(19) United States
(12) Patent Application Publication
(10) Pub. No.: US 2015/0256822 A1
(43) Pub. Date: Sep. 10, 2015

(54) Method and Apparatus for Assessing Video Freeze Distortion Degree

(71) Applicant: Huawei Technologies Co., Ltd., Shenzhen (CN)

(72) Inventors: Shan Gao, Shenzhen (CN); Lina Sun, Shenzhen (CN)

(21) Appl. No.: 14/721,610

(22) Filed: May 26, 2015

Related U.S. Application Data
(63) Continuation of application No. PCT/CN2013/080892, filed on Aug. 6, 2013.

(30) Foreign Application Priority Data
Feb. 20, 2013 (CN) 201310054674.5

(51) Int. Cl. H04N 17/00; H04N 5/38; H04N 5/14

(52) U.S. Cl. CPC H04N 17/004; H04N 5/145; H04N 5/38

(57) ABSTRACT

A method and an apparatus for assessing a video freeze distortion degree. The method includes acquiring a frame rate and a freeze feature parameter of a freeze event that are of a video stream, and the freeze event is used to represent a pause of the video stream; and acquiring a freeze event distortion value of the video stream according to the frame rate and the freeze feature parameter that are of the video stream, where the freeze event distortion value is used to represent a distortion degree of the video stream. The method and the apparatus for assessing a video freeze distortion degree in the embodiments of the present invention are more in line with subjective feelings of human, and improve accuracy of a distortion degree assessment.

### CROSS-REFERENCE TO RELATED APPLICATIONS

This application is a continuation of International Application No. PCT/CN2013/080892, filed on Aug. 6, 2013, which claims priority to Chinese Patent Application No. 201310054674.5, filed on Feb. 20, 2013, both of which are hereby incorporated by reference in their entireties.

### TECHNICAL FIELD

The present invention relates to the field of communications technologies, and more specifically, to a method and an apparatus for assessing a video freeze distortion degree.

### BACKGROUND

In a background of rapid development of network videos, because data volume of video services is large, a real-time requirement of the video services is high, and users are highly sensitive to the video services, an operator needs to monitor quality of a transmitted video service and adopt a corresponding measure in time to perform adjustment, so as to ensure an experience requirement of a user on the video services. Quality of a network video is affected by many complex factors, and an assessment on network video distortion quality is an important technology essential for a network video application.

However, in an existing method for assessing a no-reference objective video distortion degree, factors considered are not comprehensive and cannot accurately reflect subjective feelings of human, which has a certain limitation; and therefore, accuracy of distortion degree prediction is low.

### SUMMARY

Embodiments of the present invention provide a method and an apparatus for assessing a video freeze distortion degree, which can improve accuracy of distortion degree prediction.

According to a first aspect, a method for assessing a video freeze distortion degree is provided, including acquiring a frame rate and a freeze feature parameter of a freeze event that are of a video stream, where the freeze feature parameter of the freeze event is correlated with duration of the freeze event of the video stream, and the freeze event is used to represent a pause of the video stream; and acquiring a freeze event distortion value of the video stream according to the frame rate and the freeze feature parameter of the freeze event that are of the video stream, where the freeze event distortion value is used to represent a distortion degree of the video stream.

With reference to the first aspect, in a first possible implementation manner of the first aspect, the duration of the freeze event is represented using freeze time or represented using a quantity of freeze frames.

With reference to the first possible implementation manner of the first aspect, in a second possible implementation manner of the first aspect, when the duration of the freeze event is represented using the quantity of freeze frames, that the freeze feature parameter of the freeze event is correlated with duration of the freeze event of the video stream includes that the freeze feature parameter of the freeze event is represented using a proportional relationship between the quantity of freeze frames and a total quantity of video frames of the video stream; or that the freeze feature parameter of the freeze event is represented using a proportional relationship between the quantity of freeze frames and a quantity of continuous played video frames of the video stream.

With reference to the second possible implementation manner of the first aspect, in a third possible implementation manner of the first aspect, when the freeze feature parameter of the freeze event is represented using the proportional relationship between the quantity of freeze frames and the total quantity of video frames of the video stream, the acquiring a frame rate and a freeze feature parameter of a freeze event that are of a video stream includes acquiring the frame rate of the video stream; and determining the freeze feature parameter f_freezing_length of the freeze event of the video stream according to a formula

$$f\_freezing \_length = \frac{i\_total \_num \_freezing \_frames}{i\_total \_num \_frames} ,$$

where:

i_total_num_frames indicates the total quantity of video frames of the video stream; i_total_num_freezing_frames indicates a quantity of all freeze frames corresponding to the freeze event of the video stream; and f_freezing_length indicates the freeze feature parameter of the freeze event.

With reference to the first aspect, the first possible implementation manner of the first aspect, the second possible implementation manner of the first aspect, or the third possible implementation manner of the first aspect, in a fourth possible implementation manner of the first aspect, the acquiring a freeze event distortion value of the video stream according to the frame rate and the freeze feature parameter of the freeze event that are of the video stream includes acquiring the freeze event distortion value of the video stream according to a formula

$$freezing\_artifact \_value = \frac{{a}_{1}}{{a}_{2} + \frac{{a}_{3}}{fps \cdot f\_freezing {\_length}^{{a}_{4}}}} ,$$

where:

fps is the e frame rate of the video stream; f_freezing_length is the freeze feature parameter of the freeze event of the video stream; freezing_artifact_value is the freeze event distortion value; and a₁, a₂, a₃, and a₄ are positive constants.

With reference to the first aspect, the first possible implementation manner of the first aspect, the second possible implementation manner of the first aspect, or the third possible implementation manner of the first aspect, in a fifth possible implementation manner of the first aspect, the method further includes acquiring a video motion feature parameter that is of the video stream and is correlated with at least one of a motion change degree and motion consistency that are of the video stream; and the acquiring a freeze event distortion value of the video stream according to the frame rate and the freeze feature parameter of the freeze event that are of the video stream includes acquiring the freeze event distortion value of the video stream according to the video motion feature parameter, the frame rate, and the freeze feature parameter of the freeze event that are of the video stream.

With reference to the fifth possible implementation manner of the first aspect, in a sixth possible implementation manner of the first aspect, the acquiring a video motion feature parameter of the video stream includes determining the video motion feature parameter of the video stream according to a motion vector of a coded frame that is before the freeze event of the video stream occurs; or determining the video motion feature parameter of the video stream according to a motion vector of a coded frame that is after the freeze event of the video stream ends; or determining the video motion feature parameter of the video stream according to a motion vector of a coded frame that is before the freeze event of the video stream occurs and a motion vector of a coded frame that is after the freeze event of the video stream ends; or determining the video motion feature parameter of the video stream according to motion vectors of all coded frames of the video stream.

With reference to the sixth possible implementation manner of the first aspect, in a seventh possible implementation manner of the first aspect, the determining the video motion feature parameter of the video stream according to a motion vector of a coded frame that is before the freeze event of the video stream occurs includes determining the video motion feature parameter of the video stream according to a motion vector of the last decoded or displayed coded frame that is before the freeze event of the video stream occurs.

With reference to the fifth possible implementation manner of the first aspect, the sixth possible implementation manner of the first aspect, or the seventh possible implementation manner of the first aspect, in an eighth possible implementation manner of the first aspect, the acquiring the freeze event distortion value of the video stream according to the video motion feature parameter, the frame rate, and the freeze feature parameter of the freeze event that are of the video stream includes determining the freeze event distortion value of the video stream according to a formula

$$freezing\_artifact \_value = \frac{{a}_{9}}{{a}_{10} + \frac{{a}_{11}}{fps \cdot f\_freezing {\_length}^{{a}_{12}} \cdot {MV}^{{a}_{13}}}} ,$$

where: fps is the frame rate of the video stream; f_freezing_length is the freeze feature parameter of the freeze event of the video stream; MV is the video motion feature parameter of the video stream; and a₉, a₁₀, a₁₁, a₁₂, and a₁₃ are positive constants.

With reference to the fifth possible implementation manner of the first aspect, the sixth possible implementation manner of the first aspect, the seventh possible implementation manner of the first aspect, or the eighth possible implementation manner of the first aspect, in a ninth possible implementation manner of the first aspect, a direction of a correlation between the video motion feature parameter and the motion change degree of the video stream is consistent with a direction of a correlation between the video motion feature parameter and the freeze event distortion value, and a direction of a correlation between the video motion feature parameter and the motion consistency of the video stream is consistent with the direction of the correlation between the video motion feature parameter and the freeze event distortion value.

With reference to the first aspect, the first possible implementation manner of the first aspect, the second possible implementation manner of the first aspect, the third possible implementation manner of the first aspect, the fourth possible implementation manner of the first aspect, the fifth possible implementation manner of the first aspect, the sixth possible implementation manner of the first aspect, the seventh possible implementation manner of the first aspect, the eighth possible implementation manner of the first aspect, or the ninth possible implementation manner of the first aspect, in a tenth possible implementation manner of the first aspect, the frame rate is in a positive correlation with the freeze event distortion value, and a direction of a correlation between the freeze feature parameter of the freeze event and the duration of the freeze event is consistent with a direction of a correlation between the freeze feature parameter of the freeze event and the freeze event distortion value.

According to a second aspect, an apparatus for assessing a video freeze distortion degree is provided, including a first acquiring unit configured to acquire a frame rate and a freeze feature parameter of a freeze event that are of a video stream, where the freeze feature parameter of the freeze event is correlated with duration of the freeze event of the video stream, and the freeze event is used to represent a pause of the video stream; and a second acquiring unit configured to acquire a freeze event distortion value of the video stream according to the frame rate and the freeze feature parameter of the freeze event that are of the video stream, where the freeze event distortion value is used to represent a distortion degree of the video stream.

With reference to the second aspect, in a first possible implementation manner of the second aspect, the duration of the freeze event is represented using freeze time or represented using a quantity of freeze frames.

With reference to the first possible implementation manner of the second aspect, in a second possible implementation manner of the second aspect, when the duration of the freeze event is represented using the quantity of freeze frames, that the freeze feature parameter of the freeze event is correlated with duration of the freeze event of the video stream includes that the freeze feature parameter of the freeze event is represented using a proportional relationship between the quantity of freeze frames and a total quantity of video frames of the video stream; or that the freeze feature parameter of the freeze event is represented using a proportional relationship between the quantity of freeze frames and a quantity of continuous played video frames of the video stream.

With reference to the second possible implementation manner of the second aspect, in a third possible implementation manner of the second aspect, when the freeze feature parameter of the freeze event is represented using the proportional relationship between the quantity of freeze frames and the total quantity of video frames of the video stream, the first acquiring unit is configured to acquire the frame rate of the video stream; and determine the freeze feature parameter f_freezing_length of the freeze event of the video stream according to a formula

$$f\_freezing \_length = \frac{i\_total \_num \_freezing \_frames}{i\_total \_num \_frames} ,$$

where: i_total_num_frames indicates the total quantity of video frames of the video stream; i_total_num_freezing_frames indicates a quantity of all freeze frames corresponding to the freeze event of the video stream; and f_freezing_length indicates the freeze feature parameter of the freeze event.

With reference to the second aspect, the first possible implementation manner of the second aspect, or the second possible implementation manner of the second aspect, or the third possible implementation manner of the second aspect, in a fourth possible implementation manner of the second aspect, the second acquiring unit is configured to acquire the freeze event distortion value of the video stream according to a formula

$$freezing\_artifact \_value = \frac{{a}_{1}}{{a}_{2} + \frac{{a}_{3}}{fps \cdot f\_freezing {\_length}^{{a}_{4}}}} ,$$

where: fps is the frame rate of the video stream; f_freezing_length is the freeze feature parameter of the freeze event of the video stream; freezing_artifact_value is the freeze event distortion value; and a₁, a₂, a₃, and a₄ are positive constants.

With reference to the second aspect, the first possible implementation manner of the second aspect, the second possible implementation manner of the second aspect, or the third possible implementation manner of the second aspect, in a fifth possible implementation manner of the second aspect, the first acquiring unit is further configured to acquire a video motion feature parameter that is of the video stream and is correlated with at least one of a motion change degree and motion consistency that are of the video stream; and the second acquiring unit is configured to acquire the freeze event distortion value of the video stream according to the video motion feature parameter, the frame rate, and the freeze feature parameter of the freeze event that are of the video stream.

With reference to the fifth possible implementation manner of the second aspect, in a sixth possible implementation manner of the second aspect, the first acquiring unit is configured to determine the video motion feature parameter of the video stream according to a motion vector of a coded frame that is before the freeze event of the video stream occurs; or determine the video motion feature parameter of the video stream according to a motion vector of a coded frame that is after the freeze event of the video stream ends; or determine the video motion feature parameter of the video stream according to a motion vector of a coded frame that is before the freeze event of the video stream occurs and a motion vector of a coded frame that is after the freeze event of the video stream ends; or determine the video motion feature parameter of the video stream according to motion vectors of all coded frames of the video stream.

With reference to the sixth possible implementation manner of the second aspect, in a seventh possible implementation manner of the second aspect, the first acquiring unit is configured to determine the video motion feature parameter of the video stream according to a motion vector of the last decoded or displayed coded frame that is before the freeze event of the video stream occurs.

With reference to the fifth possible implementation manner of the second aspect, the sixth possible implementation manner of the second aspect, or the seventh possible implementation manner of the second aspect, in an eighth possible implementation manner of the second aspect, the second acquiring unit is configured to determine the freeze event distortion value of the video stream according to a formula

$$freezing\_artifact \_value = \frac{{a}_{9}}{{a}_{10} + \frac{{a}_{11}}{fps \cdot f\_freezing {\_length}^{{a}_{12}} \cdot {MV}^{{a}_{13}}}} ,$$

where: fps is the frame rate of the video stream; f_freezing_length is the freeze feature parameter of the freeze event of the video stream; MV is the video motion feature parameter of the video stream; and a₉, a₁₀, a₁₁, a₁₂, and a₁₃ are positive constants.

With reference to the fifth possible implementation manner of the second aspect, the sixth possible implementation manner of the second aspect, the seventh possible implementation manner of the second aspect, or the eighth possible implementation manner of the second aspect, in a ninth possible implementation manner of the second aspect, a direction of a correlation between the video motion feature parameter and the motion change degree of the video stream is consistent with a direction of a correlation between the video motion feature parameter and the freeze event distortion value, and a direction of a correlation between the video motion feature parameter and the motion consistency of the video stream is consistent with the direction of the correlation between the video motion feature parameter and the freeze event distortion value.

With reference to the second aspect, the first possible implementation manner of the second aspect, the second possible implementation manner of the second aspect, the third possible implementation manner of the second aspect, the fourth possible implementation manner of the second aspect, the fifth possible implementation manner of the second aspect, the sixth possible implementation manner of the second aspect, the seventh possible implementation manner of the second aspect, the eighth possible implementation manner of the second aspect, or the ninth possible implementation manner of the second aspect, in a tenth possible implementation manner of the second aspect, the frame rate is in a positive correlation with the freeze event distortion value, and a direction of a correlation between the freeze feature parameter of the freeze event and the duration of the freeze event is consistent with a direction of a correlation between the freeze feature parameter of the freeze event and the freeze event distortion value.

Therefore, in the embodiments of the present invention, by acquiring a frame rate of a video stream and a freeze feature parameter correlated with duration of a freeze event of the video stream, and acquiring a freeze event distortion value of the video stream according to the frame rate of the video stream and the freeze feature parameter, when an assessment on a freeze event distortion degree is performed, factors considered are more comprehensive and more in line with subjective feelings of people, so that accuracy of distortion degree prediction is improved.

### BRIEF DESCRIPTION OF DRAWINGS

To describe the technical solutions in the embodiments of the present invention more clearly, the following briefly introduces the accompanying drawings required for describing the embodiments of the present invention. The accompanying drawings in the following description show merely some embodiments of the present invention, and a person of ordinary skill in the art may still derive other drawings from these accompanying drawings without creative efforts.

FIG. 1 is a schematic flowchart of a method for assessing a video freeze distortion degree according to an embodiment of the present invention;

FIG. 2 is a schematic block diagram of an apparatus for assessing a video freeze distortion degree according to an embodiment of the present invention;

FIG. 3 is a schematic block diagram of another apparatus for assessing a video freeze distortion degree according to an embodiment of the present invention;

FIG. 4 is an application scenario diagram of an apparatus for assessing a video freeze distortion degree according to an embodiment of the present invention; and

FIG. 5 is an application scenario diagram of an apparatus for assessing a video freeze distortion degree according to another embodiment of the present invention.

### DESCRIPTION OF EMBODIMENTS

The following clearly describes the technical solutions in the embodiments of the present invention with reference to the accompanying drawings in the embodiments of the present invention. The described embodiments are a part rather than all of the embodiments of the present invention. All other embodiments obtained by a person of ordinary skill in the art based on the embodiments of the present invention without creative efforts shall fall within the protection scope of the present invention.

It should be understood that, the technical solutions of the embodiments of the present invention may be applied to various communications systems, such as: a Global System for Mobile Communications (GSM) system, a Code Division Multiple Access (CDMA) system, a Wideband Code Division Multiple Access (WCDMA) system, a general packet radio service (GPRS), a Long Term Evolution (LTE) system, an LTE frequency division duplex (FDD) system, an LTE time division duplex (TDD), a Universal Mobile Telecommunications System (UMTS), or the like.

A method for assessing a video freeze distortion degree in an embodiment of the present invention may be used to assess video distortion quality.

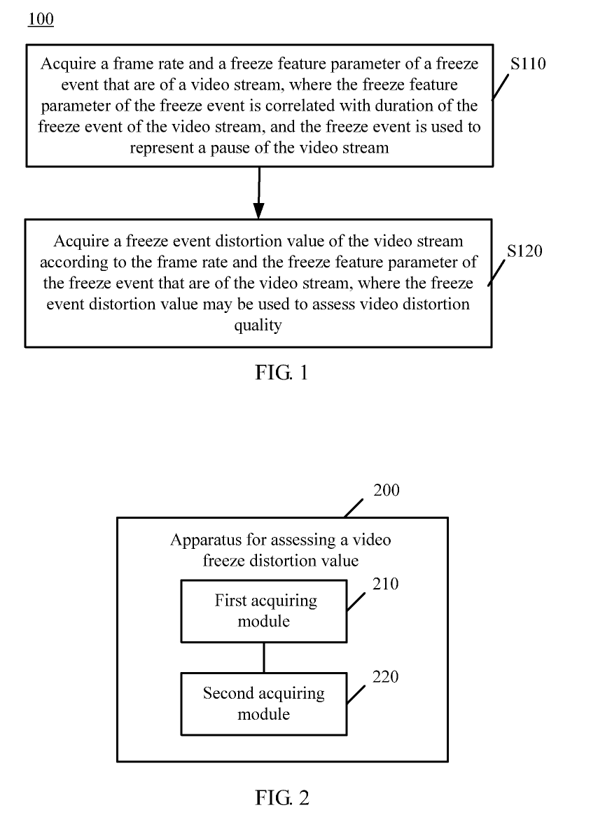

FIG. 1 is a schematic flowchart of a method 100 for assessing a video freeze distortion degree according to an embodiment of the present invention. As shown in FIG. 1, the method 100 includes the following steps:

S110. Acquire a frame rate and a freeze feature parameter of a freeze event that are of a video stream, where the freeze feature parameter of the freeze event is correlated with duration of the freeze event of the video stream, and the freeze event is used to represent a pause of the video stream.

It should be noted that the freeze feature parameter in this embodiment of the present invention is correlated with the duration of the freeze event of the video stream, and their relativity appears as that, for obtaining of the freeze feature parameter, refer to the duration of freeze time event or an equivalent variant that can reflect the duration, which is not specifically limited herein. For example, the duration of the freeze event may be represented using time, or may be represented using a quantity of freeze frames.

In this embodiment of the present invention, when the duration of the freeze event is represented using the quantity of freeze frames, that the freeze feature parameter of the freeze event is correlated with duration of the freeze event of the video stream includes that the freeze feature parameter of the freeze event is represented using a proportional relationship between the quantity of freeze frames and a total quantity of video frames of the video stream; or that the freeze feature parameter of the freeze event is represented using a proportional relationship between the quantity of freeze frames and a quantity of continuous played video frames of the video stream.

Further, the freeze feature parameter may be the duration of the freeze event, may be a ratio of the duration of the freeze event to duration of the continuous played video frames of the video stream, may be a ratio of the duration of the freeze event to (the duration of the continuous played video frames of the video stream plus the duration of the freeze event), may be a quantity of freeze frames corresponding to one or more freeze events, may be a ratio of a quantity of freeze frames corresponding to one or more freeze events to a quantity of continuously played video frames of the video stream, or may be a ratio of a quantity of freeze frames corresponding to one or more freeze events to the total quantity of video frames of the video stream. The total quantity of video frames of the video stream refers to a sum of the quantity of continuously played video frames of the video stream and the quantity of freeze frames, that is, a quantity of video frames that should be played in a case in which the video stream is normally played; or the total quantity of video frames of the video stream is a sum of all played video frames of the video stream.

S120. Acquire a freeze event distortion value of the video stream according to the frame rate and the freeze feature parameter of the freeze event that are of the video stream, where the freeze event distortion value may be used to assess video distortion quality.

In this embodiment of the present invention, the frame rate of the video stream is in a positive correlation with the freeze event distortion value, and a direction of a correlation between the freeze feature parameter and the duration of the freeze event is consistent with a direction of a correlation between the freeze feature parameter and the freeze event distortion value.

In this embodiment of the present invention, the frame rate of the video stream may be acquired from a code stream, may be acquired from a transmission packet header of the video stream, or may be acquired from auxiliary information externally transmitted.

In this embodiment of the present invention, besides acquiring of the frame rate and the freeze feature parameter that are of the video stream, a video motion feature parameter that is of the video stream and is correlated with at least one of a motion change degree and motion consistency that are of the video stream may further be acquired; and the freeze event distortion value of the video stream may be acquired according to the video motion feature parameter, the frame rate, and the freeze feature parameter that are of the video stream.

In this embodiment of the present invention, a direction of a correlation between the video motion feature parameter and the motion change degree of the video stream is consistent with a direction of a correlation between the video motion feature parameter and the freeze event distortion value, and a direction of a correlation between the video motion feature parameter and the motion consistency of the video stream is consistent with the direction of the correlation between the video motion feature parameter and the freeze event distortion value.

The video stream in this embodiment of the present invention refers to a video stream on which a distortion degree assessment is performed, and may be a part of a complete video stream or a complete video stream. Certainly, a distortion degree assessment may also be jointly performed on multiple complete video streams. For example, for two complete video streams A and B, the video stream A has total duration of 10 min and is divided into five clips with each clip of 2 min, and the video stream B has total duration of 5 min and is divided into five clips with each clip of 1 min. Then, a distortion degree assessment may be performed only on one or more clips in the video stream A, or a distortion degree assessment may be performed only on one or more clips in the video stream B, or a distortion degree assessment may be jointly performed on one or more clips in the video stream A and one or more clips in the video stream B.

The freeze event in this embodiment of the present invention refers to that a video pauses for a period of time, and duration during which the video pauses may be referred to as the duration of the freeze event. In a process in which the video pauses, the last frame of image before the freeze event occurs may be displayed, or another image may be displayed, for example, an image of a blank screen but with a displayed pause symbol or a comprehensive image in which the last displayed frame of image is combined with a displayed pause symbol may be displayed.

The freeze event in this embodiment of the present invention may be caused by a network delay, or may be caused by a network packet loss.

When the freeze event is caused by a network delay, because there is no packet loss, the freeze event may be a freeze event with a freeze and without frame skipping. During the freeze event, the last correctly received or decoded or displayed video frame before the freeze event occurs may be displayed, and when the freeze event ends, a video frame that should have been played during a pause of the video stream may continue to be played. Certainly, when the freeze event ends, the video frame that should have been played during the pause may also be discarded, and only a video frame after the video frame that should have been played during the pause continues to be played. In this case, the video frame that should have been played during the freeze event but is delayed to be played after the freeze event ends or the foregoing discarded video frame may be referred to as a freeze frame.

When the freeze event is caused by a network packet loss, because of a packet loss, a whole-frame loss and/or a decoding error and/or error propagation occurs, thereby causing an occurrence of a freeze event with a freeze and frame skipping. In one freeze event with a freeze and frame skipping, the video pauses once. In this case, one or more video frames of the video stream are discarded, and the last correctly received or decoded or displayed video frame before the freeze event occurs is displayed. The discarded one or more video frames may be referred to as freeze frames. It should be understood that in this embodiment of the present invention, if at least two events of a whole-frame loss, a decoding error, and error propagation simultaneously occur in a freeze event, freeze frames of the freeze event include all video frames discarded due to the at least two events of the whole-frame loss, the decoding error, and the error propagation.

In this embodiment of the present invention, after a freeze event occurs, if a video frame appears, where the video frame itself has no packet loss, and during decoding, is not affected by error propagation caused by a previous packet loss, or if a video frame appears, where the video frame itself has no packet loss, and during decoding, a reference frame of the frame is not affected by a packet loss and/or error propagation, the freeze event may be made to end.

In this embodiment of the present invention, the duration of the freeze event may be represented using time, or may be represented using a quantity of freeze frames.

In this embodiment of the present invention, that the frame rate of the video stream is in a positive correlation with the freeze event distortion value means that a larger frame rate of the video stream indicates a larger freeze event distortion value, and a smaller frame rate of the video stream indicates a smaller freeze event distortion value.

In this embodiment of the present invention, that a direction of a correlation between the freeze feature parameter and the duration of the freeze event is consistent with a direction of a correlation between the freeze feature parameter and the freeze event distortion value means that longer duration of the freeze event indicates a larger freeze event distortion value, and shorter duration of the freeze event indicates a smaller freeze event distortion value. That is, when the direction of the correlation between the freeze feature parameter and the duration of the freeze event is a positive correlation (larger duration of the freeze event indicates a larger freeze feature parameter, and smaller duration of the freeze event indicates a smaller freeze feature parameter), the direction of the correlation between the freeze feature parameter and the freeze event distortion value is also a positive correlation (a larger freeze feature parameter indicates a larger freeze event distortion value, and a smaller freeze feature parameter indicates a smaller freeze event distortion value). When the direction of the correlation between the freeze feature parameter and the duration of the freeze event is a negative correlation (larger duration of the freeze event indicates a smaller freeze feature parameter, and smaller duration of the freeze event indicates a larger freeze feature parameter), the direction of the correlation between the freeze feature parameter and the freeze event distortion value is also a negative correlation (a larger freeze feature parameter indicates a smaller freeze event distortion value, and a smaller freeze feature parameter indicates a larger freeze event distortion value).

In this embodiment of the present invention, a video motion refers to a temporal change of video content, which may be caused by a camera motion or caused by a change of the video content, may be a partial change, or may be a global change, for example, a translation motion, a zooming motion, a pan motion, a tilt motion, or a motion of an object. The video motion feature parameter represents a motion change degree (that is, a degree of a temporal change of the video content (for example, fast, slow, large, or small)) of at least one motion and/or motion consistency (that is, a temporal consistency change of the video content (for example, a regular motion or an irregular motion)) of at least one motion. A more regular motion indicates a more consistent motion, for example, a translation motion, a zooming motion, a pan motion, or a global motion; and conversely, a more irregular motion indicates a more inconsistent motion.

In this embodiment of the present invention, that a direction of a correlation between the video motion feature parameter and the motion change degree of the video stream is consistent with a direction of a correlation between the video motion feature parameter and the freeze event distortion value means that a higher motion change degree of the video stream indicates a larger freeze event distortion value. That is, when the direction of the correlation between the video motion feature parameter and the motion change degree of the video stream is a positive correlation (a higher motion change degree indicates a larger video motion feature parameter, and a lower motion change degree indicates a smaller video motion feature parameter), the direction of the correlation between the video motion feature parameter and the freeze event distortion value is also a positive correlation (a larger video motion feature parameter indicates a larger freeze event distortion value, and a smaller video motion feature parameter indicates a smaller freeze event distortion value). When the direction of the correlation between the video motion feature parameter and the motion change degree of the video stream is a negative correlation (a higher motion change degree indicates a smaller video motion feature parameter, and a lower motion change degree indicates a larger video motion feature parameter), the direction of the correlation between the video motion feature parameter and the freeze event distortion value is also a negative correlation (a larger video motion feature parameter indicates a smaller freeze event distortion value, and a smaller video motion feature parameter indicates a larger freeze event distortion value).

In this embodiment of the present invention, that a direction of a correlation between the video motion feature parameter and the motion consistency of the video stream is consistent with the direction of the correlation between the video motion feature parameter and the freeze event distortion value means that a more consistent motion of the video stream indicates a larger freeze event distortion value. That is, when the direction of the correlation between the video motion feature parameter and the motion consistency of the video stream is a positive correlation (a more consistent motion indicates a larger video motion feature parameter, and a more inconsistent motion indicates a smaller video motion feature parameter), the direction of the correlation between the video motion feature parameter and the freeze event distortion value is also a positive correlation (a larger video motion feature parameter indicates a larger freeze event distortion value, and a smaller video motion feature parameter indicates a smaller freeze event distortion value). When the direction of the correlation between the video motion feature parameter and the motion consistency of the video stream is a negative correlation (a more consistent motion indicates a smaller video motion feature parameter, and a more inconsistent motion indicates a larger video motion feature parameter), the direction of the correlation between the video motion feature parameter and the freeze event distortion value is also a negative correlation (a larger video motion feature parameter indicates a smaller freeze event distortion value, and a smaller video motion feature parameter indicates a larger freeze event distortion value).

In this embodiment of the present invention, the motion change degree and the motion consistency that are of the video stream both may be acquired using a motion vector of an inter-frame coded frame, and the motion vector is adjusted to an interval, for example, an interval [−128.0, 128.0]. Optionally, the motion vector that is adjusted to an interval may further be multiplied by the frame rate. The motion change degree is acquired using the adjusted motion vector.

To understand the present invention more clearly, the following describes this embodiment of the present invention in detail, and an example in which the foregoing directions of the correlations are positive correlations is used for description, but the present invention is not limited thereto.

The following describes in detail how to acquire the video motion feature parameter of the video stream.

In this embodiment of the present invention, the video motion feature parameter of the video stream may be determined according to a motion vector (for example, an average of motion vectors of all displayed or decoded inter-frame coded frames of the video stream) of an inter-frame coded frame of the video stream or a discrete cosine transform (DCT) coefficient (for example, an average of DCT coefficients of all displayed or decoded coded frames (inter-frame coded frames and/or intra-frame coded frames) of the video stream) of a coded frame of the video stream.

In this embodiment of the present invention, the video motion feature parameter of the video stream may be determined according to a motion vector of an inter-frame coded frame that is before the freeze event of the video stream occurs; the video motion feature parameter of the video stream may be determined according to a motion vector of an inter-frame coded frame that is after the freeze event of the video stream ends; the video motion feature parameter of the video stream may be determined according to a motion vector of an inter-frame coded frame that is before the freeze event of the video stream occurs and a motion vector of an inter-frame coded frame that is after the freeze event of the video stream ends; the video motion feature parameter of the video stream may be determined according to a DCT coefficient of a coded frame that is before the freeze event of the video stream occurs; the video motion feature parameter of the video stream may be determined according to a DCT coefficient of a coded frame that is after the freeze event of the video stream ends; or the video motion feature parameter of the video stream may be determined according to a DCT coefficient of a coded frame that is before the freeze event of the video stream occurs and a DCT coefficient of a coded frame that is after the freeze event of the video stream ends.

In this embodiment of the present invention, the video motion feature parameter of the video stream may be determined according to a motion vector of the last decoded or displayed inter-frame coded frame that is before the freeze event of the video stream occurs.

The following describes using an example in which the video motion feature parameter correlated with the motion change degree of the video stream is determined according to formulas (1), (2), (3), and (4).

For example, the video motion feature parameter MV of the video stream may be acquired according to the formula (1):

$$MV = {\sum }_{i = 1}^{n} {d\_mv [ i ]}^{d \_ MVInfluence} \qquad ( 1 )$$

d_MVInfluence is a positive constant, for example, 0.05, or certainly may be another positive constant, where for video streams of different resolutions, different values may be used, or a same value may be used, and the values or the value may be obtained by means of training or an empirical value; or d_MVInfluence may be a value correlated with an average of all motion vectors before the freeze event occurs; d_mv[i] indicates a value corresponding to a motion vector of the last decoded or displayed inter-frame coded frame before an i^{th} freeze event of the video stream occurs; i=1 indicates a first freeze event of the video stream; and n indicates a total quantity of freeze events of the video stream.

Alternatively, in this embodiment of the present invention, the video motion feature parameter MV of the video stream may be acquired according to the formula (2):

$$MV = {\sum }_{i = 1}^{n} d\_MVInfluence \cdot d\_mv [ i ] \qquad ( 2 )$$

d_MVInfluence is a positive constant, for example, 2.5, or certainly may be another positive constant, where for video streams of different resolutions, different values may be used, and may be obtained by means of training or an empirical value; or d_MVInfluence may be a value correlated with an average of all motion vectors before the freeze event occurs; d_mv[i] indicates a value corresponding to a motion vector of the last decoded or displayed inter-frame coded frame before an i^{th} freeze event of the video stream occurs; i=1 indicates a first freeze event of the video stream; and n indicates a total quantity of freeze events of the video stream.

In this embodiment of the present invention, d_mv[i] in the formula (1) or the formula (2) may be acquired using the formula (3):

$$d\_mv [ i ] = \frac{{\sum }_{l = 1}^{g} {mvmedian [ i ]}_{l}}{g} \qquad ( 3 )$$

The mvmedian[i]ₗ indicates a value corresponding to a motion vector of an l^{th} macroblock in the last inter-frame coded frame before the i^{th} freeze event of the video stream occurs; and g indicates a total quantity of macroblocks owned by the last decoded or displayed inter-frame coded frame before the i^{th} freeze event of the video stream occurs.

In this embodiment of the present invention, d_mv[i] in the formula (1) or t he formula (2) may also be acquired using the formula (4):

$$d\_mv [ i ] = {\sum }_{l = 1}^{g} {mvmedian [ i ]}_{l} \qquad ( 4 )$$

The mvmedian[i]ₗ indicates a value corresponding to a motion vector of an l^{th} macroblock in the last decoded or displayed inter-frame coded frame before the i^{th} freeze event of the video stream occurs; and g indicates a total quantity of macroblocks owned by the last decoded or displayed inter-frame coded frame before the i^{th} freeze event of the video stream occurs. d_mv[i] in the foregoing formulas (3) and (4) is obtained by separately summarizing values corresponding to motion vectors of all macroblocks of the frame or averaging values corresponding to motion vectors of all macroblocks of the frame. Certainly, d_mv[i] in this embodiment of the present invention may also be obtained in another manner. For example, the d_mv[i] is obtained by calculating a median of the values corresponding to the motion vectors of all the macroblocks of the frame.

In this embodiment of the present invention, after d_mv[i] is acquired according to the formulas (3) and (4), the d_mv[i] may be adjusted and then MV is calculated. For example, the d_mv[i] may be adjusted to an interval [C1, C2], where normalization processing may be performed on d_mv[i], that is, d_mv[i] is adjusted to [0.0, 1.0]. For example, the d_mv[i] is adjusted using

$$min ( C 2 , \frac{d\_mv [ i ] \cdot C 4}{C 3} )$$

so as to adjust d_mv[i] to [0.0, 1.0], where C2=1.0, and C3 and C4 are constants, for example, C3=64.0 and C4=1/4. Certainly, the d_mv[i] may also be adjusted to another interval, which is not limited in this embodiment of the present invention.

In this embodiment of the present invention, the value mvmedian[i]ₗ corresponding to the motion vector of the l^{th} macroblock may be determined according to all motion vectors of the l^{th} macroblock, and may be performed using the following two methods:

### Method 1

1) Adjust mv_{x,t,l} and mv_{y,t,l} of the macroblock l to an interval [b1, b2], where mv_{x,t,l} is a motion vector of a t^{th} block of the macroblock l in a horizontal direction, mv_{y,t,l} is a motion vector of the t^{th} block of the macroblock l in a vertical direction, t=1,2,3 . . . T, and T is a total quantity of blocks owned by the macroblock l; and b1 and b2 are constants, for example, b1=−128.0 and b2=128.0, or certainly, b1 and b2 may be other constants, and may be obtained by means of training or an empirical value.

2) Respectively calculate medians of the adjusted my_{x,t,l} and mv_{y,t,l}, and respectively use the medians as a motion vector value mv_{x,l} of the macroblock in the horizontal direction and a motion vector value mv_{y,l} of the macroblock in the vertical direction.

3) Acquire mvmedian[i]ₗ using a formula mvmedian[i]ₗ=\sqrt{(mv_{x,l})²+(mv_{y,l})²} or mvmedian[i]ₗ=|mv_{x,l}|+|mv_{y,l}|.

4) Adjust mvmedian[i]ₗ to [b3, b4], where b3 and b4 are constants, and may be obtained by means of training or an empirical value.

### Method 2

1) Adjust mv_{x,t,l} and mv_{y,t,l} of the macroblock l to an interval [b1, b2], where mv_{x,t,l} is a motion vector of a t^{t}h block of the macroblock l in a horizontal direction, mv_{y,t,l} is a motion vector of the t^{th} block of the macroblock l in a vertical direction, t=1,2,3 . . . T, and T is a total quantity of blocks owned by the macroblock l; and b1 and b2 are constants, for example, b1=−128.0 and b2=128.0, or certainly, b1 and b2 may be other constants, and may be obtained by means of training or an empirical value.

2) Calculate values of all the motion vectors of the macroblock l using a formula mv_{t,l}=\sqrt{(mv_{x,t,l})²+(mv_{y,t,l})²} or mv_{t,l}=|mv_{x,l}|+|mv_{y,l}|.

3) Calculate a median of mv_{t,l} of the macroblock l, and use the median as a median mvmedian[i]ₗ of a motion vector of the macroblock.

4) Adjust mvmedian[i]ₗ to [b5, b6], where b5 and b6 are constants, and may be obtained by means of training or an empirical value.

It should be understood that, the foregoing two methods are only specific implementation manners for acquiring a value corresponding to a motion vector of a macroblock. There may further be another implementation manner in this embodiment of the present invention. For example, for the method 1, adjustment in steps 1) and/or 4) is not performed; and for method 2, adjustment in steps 1) and/or 4) is not performed either. For another example, steps 2) and 3) in the method 1 and the method 2 are determined in another manner. For another example, for the method 1 and the method 2, after mv_{x,t,l} and mv_{y,t,l} are adjusted to the interval [b1, b2], the adjusted values may further be separately multiplied by the frame rate to obtain mv_{x,t,l} and mv_{y,t,l}, which may be determined according to an actual situation, and is not limited in this embodiment of the present invention. It should further be understood that in some standards, for example, in the High Efficiency Video Coding (HEVC) standard, the macroblock in this embodiment of the present invention may also be referred to as a coding unit (coding unit).

In this embodiment of the present invention, though the foregoing makes description using an example in which the video motion feature parameter of the video stream is determined using the formula (1) or (2) and according to a motion vector of the last decoded or displayed inter-frame coded frame that is before each freeze event occurs, there may further be another implementation manner in the present invention. For example, the video motion feature parameter of the video stream is determined using a motion vector of any (for example, a first) decoded or displayed inter-frame coded frame that is after each freeze event ends; or the video motion feature parameter of the video stream is jointly determined using one or more motion vectors of any one or more (for example, a last) decoded or displayed inter-frame coded frames that are before each freeze event occurs and one or more motion vectors of any one or more (for example, a first) decoded or displayed inter-frame coded frames that are after each freeze event ends (for example, an average of a value corresponding to a motion vector of the last decoded or displayed inter-frame coded frame that is before each freeze event occurs and a value corresponding to a motion vector of a first decoded or displayed inter-frame coded frame that is after each freeze event ends is first obtained, and then the video motion feature parameter of the video stream is determined according to the average, where for a method for acquiring the value corresponding to the motion vector of the first decoded or displayed inter-frame coded frame that is after each freeze event ends, refer to a method for acquiring the value corresponding to the motion vector of the last decoded or displayed inter-frame coded frame that is before each freeze event occurs); or the video motion feature parameter of the video stream is determined using a DCT coefficient of any (for example, the last) decoded or displayed coded frame that is before each freeze event occurs; or the video motion feature parameter of the video stream is determined using a DCT coefficient of any (for example, a first) decoded or displayed coded frame that is after each freeze event ends; or the video motion feature parameter of the video stream is jointly determined using a DCT coefficient of any (for example, a last) decoded or displayed coded frame that is before each freeze event occurs and a DCT coefficient of any (for example, a first) decoded or displayed coded frame that is after each freeze event ends; or the video motion feature parameter of the video stream is determined using motion vectors of multiple decoded or displayed inter-frame coded frames that are before each freeze event occurs (for example, an average of values corresponding to the motion vectors of the multiple decoded or displayed inter-frame coded frames is obtained, and then the video motion feature parameter of the video stream is determined according to the average); or the video motion feature parameter of the video stream is determined using motion vectors of multiple decoded or displayed inter-frame coded frames that are after each freeze event ends; or the video motion feature parameter of the video stream is determined using DCT coefficients of multiple decoded or displayed coded frames that are before each freeze event occurs; or the video motion feature parameter of the video stream is determined using DCT coefficients of multiple decoded or displayed coded frames that are after each freeze event ends.

The following describes using an example in which the video motion feature parameter correlated with the motion consistency of the video stream is determined using formulas (5), (6), (7), (8), (9), (10), and (11).

In this embodiment of the present invention, the video motion feature parameter MW of the video stream may also be determined according to the formula (5):

$$MV = \frac{{\sum }_{i = 1}^{n} max ( {pan\_factor}_{i} , {zoom\_factor}_{i} )}{n} \qquad ( 5 )$$

i=1 indicates a first freeze event of the video stream; n indicates a total quantity of freeze events of the video stream; pan_factorᵢ indicates a pan motion feature parameter or a translation motion feature parameter corresponding to an i^{th} freeze event of the video stream (in the case of a pan motion or a translation motion, pan_factorᵢ is relatively larger, which may be understood as that the motion is more consistent); zoom_factorᵢ indicates a zooming motion feature parameter corresponding to the i^{th} freeze event of the video stream (in the case of a zooming motion, zoom_factorᵢ is relatively larger, which may be understood as that the motion is more consistent).

In this embodiment of the present invention, the foregoing pan_factorᵢ and zoom_factorᵢ may be determined according to multiple methods; for example, the foregoing pan_factorᵢ and zoom_factorᵢ and may be determined using the following three methods:

### Method A

1) Determine pan_factorᵢ using the formula (6):

$${pan\_factor}_{i} = \frac{\sqrt{\begin{matrix}{( {\sum }_{m ∈ p} \frac{{\sum }_{t ⋐ m} {mv}_{x , t , m} \cdot {Aera}_{t , m}}{{\sum }_{t ⋐ m} {Aera}_{t , m}} )}^{2} + \\ {( {\sum }_{m ∈ p} \frac{{\sum }_{t ⋐ m} {mv}_{y , t , m} \cdot {Aera}_{t , m}}{{\sum }_{t ⋐ m} {Aera}_{t , m}} )}^{2}\end{matrix}}}{i\_nbr \_mbs} \qquad ( 6 )$$

m indicates an m^{th} macroblock; p indicates a p^{th} inter-frame coded frame (for example, a last decoded or displayed inter-frame coded frame before the i^{th} freeze event occurs or a first decoded or displayed inter-frame coded frame after the i^{th} freeze event ends); t indicates a t^{th} block in the m^{th} macroblock in the p^{th} inter-frame coded frame; Aera_{t,m} indicates an area of the t^{th} block, and in this case, Aera_{t,m} is in a unit of pixel, for example, a block size of 8×8 is 64 pixels, and a block size of 16×16 is 256 pixels; mv_{x,t,m} indicates a motion vector value of the t^{th} block in a horizontal direction, where mv_{x,t,m} may be an original motion vector value of the t^{t}h block in the horizontal direction, or may be an adjusted motion vector value (for example, a value belonging to an interval [−128.0, 128.0] with a maximum value of 128.0 and a minimum value of −128.0; for another example, a motion vector value further multiplied by the frame rate after being adjusted to [−128.0, 128.0]); mv_{y,t,m} indicates a motion vector value of the t^{th} block in a vertical direction, where mv_{y,t,m} may be an original motion vector value of the t^{th} block in the vertical direction, or may be an adjusted motion vector value (for example, a value belonging to an interval [−128.0, 128.0] with a maximum value of 128.0 and a minimum value of −128.0; for another example, a motion vector value further multiplied by the frame rate after being adjusted to [−128.0, 128.0]); and i_nbr_mbs indicates a total quantity of macroblocks owned by the p^{th} inter-frame coded frame.

2) Determine zoom_factorᵢ using the formula (7):

$${zoom\_factor}_{i} = \frac{\sqrt{\begin{matrix}{\vert \begin{matrix}{\sum }_{m ∈ {p}_{L}} \frac{{\sum }_{t ⋐ m} {mv}_{x , t , m} \cdot {Aera}_{t , m}}{{\sum }_{t ⋐ m} {Aera}_{t , m}} - \\ {\sum }_{m ∈ {p}_{L}} \frac{{\sum }_{t ⋐ m} {mv}_{x , t , m} \cdot {Aera}_{t , m}}{{\sum }_{t ⋐ m} {Aera}_{t , m}}\end{matrix} \vert}^{2} + \\ {\vert \begin{matrix}{\sum }_{m ∈ {p}_{T}} \frac{{\sum }_{t ⋐ m} {mv}_{y , t , m} \cdot {Aera}_{t , m}}{{\sum }_{t ⋐ m} {Aera}_{t , m}} - \\ {\sum }_{m ∈ {p}_{B}} \frac{{\sum }_{t ⋐ m} {mv}_{y , t , m} \cdot {Aera}_{t , m}}{{\sum }_{t ⋐ m} {Aera}_{t , m}}\end{matrix} \vert}^{2}\end{matrix}}}{i\_nbr \_mbs} \qquad ( 7 )$$

m indicates an m^{th} macroblock; p_{L} indicates a left half of a p^{th} inter-frame coded frame; p_{R} indicates a right half of the p^{th} inter-frame coded frame; p_{T} indicates an upper half of the p^{th} inter-frame coded frame; p_{B} indicates a lower half of the p^{th} inter-frame coded frame; t indicates a t^{th} block in the m^{th} macroblock in p_{L} or p_{R} or p_{T} or p_{B} in the p^{th} inter-frame coded frame; Aera_{t,m} indicates an area of the t^{th} block and is in a unit of pixel, for example, a block size of 8×8 is 64 pixels, and a block size of 16×16 is 256 pixels; mv_{x,t,m} indicates a motion vector value of the t^{th} block in a horizontal direction, where mv_{x,t,m} may be an original motion vector value of the t^{th} block in the horizontal direction, or may be an adjusted motion vector value (for example, a value belonging to an interval [−128.0, 128.0] with a maximum value of 128.0 and a minimum value of −128.0; for another example, a motion vector value further multiplied by the frame rate after being adjusted to [−128.0, 128.0]); mv_{y,t,m} indicates a motion vector value of the t^{th} block in a vertical direction, where mv_{y,t,m} may be an original motion vector value of the t^{th} block in the vertical direction, or may be an adjusted motion vector value (for example, a value belonging to an interval [−128.0, 128.0] with a maximum value of 128.0 and a minimum value of −128.0; for another example, a motion vector value further multiplied by the frame rate after being adjusted to [−128.0, 128.0]); and i_nbr_mbs indicates a total quantity of macroblocks owned by the p^{th} inter-frame coded frame.

### Method B

1) Determine pan_factorᵢ using the formula (8):

$${pan\_factor}_{i} = \frac{\sqrt{\begin{matrix}{( {\sum }_{m ∈ p} {\sum }_{t ⋐ m} {mv}_{x , t , m} \cdot {Aera}_{t , m} )}^{2} + \\ {( {\sum }_{m ∈ p} {\sum }_{t ⋐ m} {mv}_{y , t , m} \cdot {Aera}_{t , m} )}^{2}\end{matrix}}}{video\_width \cdot video\_height} \qquad ( 8 )$$

2) Determine zoom_factorᵢ using the formula (9):

$${zoom\_factor}_{i} = \frac{\sqrt{\begin{matrix}{\vert {\sum }_{m ∈ {p}_{L}} {\sum }_{t ⋐ m} {MV}_{x , t , m} \cdot {Aera}_{t , m} - {\sum }_{m ∈ {p}_{R}} {\sum }_{t ⋐ m} {mv}_{x , t , m} \cdot {Aera}_{t , m} \vert}^{2} + \\ {\vert {\sum }_{m ∈ {p}_{T}} {\sum }_{t ⋐ m} {mv}_{y , t , m} \cdot {Aera}_{t , m} - {\sum }_{m ∈ {p}_{B}} {\sum }_{t ⋐ m} {mv}_{y , t , m} \cdot {Aera}_{t , m} \vert}^{2}\end{matrix}}}{video\_width \cdot video\_height} \qquad ( 9 )$$

video_width·video_height in the formulas (8) and (9) indicates an area (in a unit of pixel) of a p^{th} inter-frame coded frame; for meanings of other parameters, refer to the formulas (6) and (7). For brevity, details are not described herein again.

### Method C

1) Determine pan_factorᵢ using the formula (10):

$${pan\_factor}_{i} = \sqrt{{( {\sum }_{m ∈ p} {\sum }_{t ⋐ m} {mv}_{x , t , m} )}^{2} + {( {\sum }_{m ∈ p} {\sum }_{t ⋐ m} {mv}_{y , t , m} )}^{2}} \qquad ( 10 )$$

2) Determine zoom_factorᵢ using the formula (11):

$${zoom\_factor}_{i} = \sqrt{\begin{matrix}{\vert {\sum }_{m ∈ {p}_{L}} {\sum }_{t ⋐ m} {mv}_{x , t , m} - {\sum }_{m ∈ {p}_{R}} {\sum }_{t ⋐ m} {mv}_{x , t , m} \vert}^{2} + \\ {\vert {\sum }_{m ∈ {p}_{T}} {\sum }_{t ⋐ m} {mv}_{y , t , m} - {\sum }_{m ∈ {p}_{B}} {\sum }_{t ⋐ m} {mv}_{y , t , m} \vert}^{2}\end{matrix}} \qquad ( 11 )$$

For meanings of parameters in the formulas (10) and (11), refer to the formulas (6) and (7). For brevity, details are not described herein again.

It should be understood that in this embodiment of the present invention, the video motion feature parameter of the video stream may also be acquired in another manner, which is not limited in this embodiment of the present invention. For example, the formula (5) may be converted to

$$MV = \frac{{\sum }_{i = 1}^{n} ( {pan\_factor}_{i} + {zoom\_factor}_{i} )}{n}$$

$$or$$

$$MV = \frac{{\sum }_{i = 1}^{n} \frac{( {pan\_factor}_{i} + {zoom\_factor}_{i} )}{2}}{n} .$$

The foregoing describes how to acquire the video motion feature parameter of the video stream, and the following describes how to acquire the freeze feature parameter of the video stream.

It should be noted that the freeze feature parameter in this embodiment of the present invention is correlated with the duration of the freeze event of the video stream, and their relativity appears as that, for obtaining of the freeze feature parameter, reference needs to be made to the duration of freeze time event or an equivalent variant that can reflect the duration, which is not specifically limited herein. For example, the duration of the freeze event may be represented using time, or may be represented using a quantity of freeze frames, or may be represented using a proportional relationship between the quantity of freeze frames and a total quantity of video frames of the video stream. The freeze feature parameter may be the duration of the freeze event, may be a ratio of the duration of the freeze event to duration of the continuous played video frames of the video stream, may be a ratio of the duration of the freeze event to (the duration of the continuous played video frames of the video stream plus the duration of the freeze event), may be a quantity of freeze frames corresponding to one or more freeze events, may be a ratio of the quantity of freeze frames corresponding to one or more freeze events to a quantity of continuously played video frames of the video stream, or may be a ratio of the quantity of freeze frames corresponding to one or more freeze events to the total quantity of video frames of the video stream. The total quantity of video frames of the video stream refers to a sum of the quantity of continuously played video frames of the video stream and the quantity of freeze frames, that is, a quantity of video frames that should be played in a case in which the video stream is normally played; or the total quantity of video frames of the video stream is a sum of all played video frames of the video stream.

In this embodiment of the present invention, when the freeze event is caused by a network delay, information (for example, a starting position of the freeze event, and the duration of the freeze event (which may be represented using time)) about the freeze event may be acquired from a video pause device, or may be fed back by a receive end of the video stream. When the freeze event is caused by a network packet loss, a video error concealment method used by a video decoder at the receive end of the video stream may be used, so that a freeze event that is the same as a freeze event obtained by the video decoder may be obtained, and information (for example, the duration of the freeze event (which may be represented using the quantity of freeze frames)) about the freeze event is obtained.

For example, the freeze feature parameter f_freezing_length of the video stream may be acquired according to a formula (12):

$$f\_freezing \_length = \frac{i\_total \_num \_freezing \_frames}{i\_total \_num \_frames} \qquad ( 12 )$$

i_total_num_frames indicates the total quantity of video frames of the video stream; and i_total_num_freezing_frames indicates a total quantity of freeze frames corresponding to the freeze event of the video stream.

In this embodiment of the present invention, after the video motion feature parameter, the frame rate, and the freeze feature parameter that are of the video stream are acquired, the freeze event distortion value of the video stream may be acquired.

For example, the freeze event distortion value freezing_artifact_value of the video stream is acquired using the following formula (13):

$$freezing\_artifact \_value = {a}_{1} \cdot ( \frac{{( \frac{f\_freezing \_length}{{a}_{2}} )}^{{a}_{3}} \cdot MV}{\frac{{a}_{4}}{fps} + {( \frac{f\_freezing \_length}{{a}_{2}} )}^{{a}_{3}} \cdot MV} ) \qquad ( 13 )$$

fps is the frame rate of the video stream; f_freezing_length is the freeze feature parameter of the video stream; MV is the video motion feature parameter of the video stream; and a₁, a₂, a₃, and a₄ are positive constants, where specific values may be obtained by means of training.

For another example, the freeze event distortion value freezing_artifact_value of the video stream is acquired using the following formula (14):

$$freezing\_artifact \_value = \frac{{a}_{9}}{{a}_{10} + \frac{{a}_{11}}{fps \cdot f\_freezing {\_length}^{{a}_{12}} \cdot {MV}^{{a}_{13}}}} \qquad ( 14 )$$

fps is the frame rate of the video stream; f_freezing_length is the freeze feature parameter of the video stream; and MV is the video motion feature parameter of the video stream. a₉, a₁₀, a₁₁, and a₁₂ are positive constants, where specific values may be obtained by means of training or an empirical value. For different resolutions, a₉, a₁₀, a₁₁, and a₁₂ may have different values. For example, in the case of a standard definition resolution, a₁₁=6.284277, a₁₂=0.725262, and a₁₃=0.089219; in the case of a 1280×720 resolution, a₁₁=4.04767, a₁₂=0.914548, and a₁₃=0.066144; and in the case of a 1920×1080 resolution, a₁₁=9.269669, a₁₂=0.758998, and a₁₃=0.064108. For another example, in the case of a standard definition resolution, a₁₁=6.2843, a₁₂=0.7253, and a₁₃=0.0892; in the case of a 1280×720 resolution, a₁₁=4.0477, a₁₂=0.9145, and a₁₃=0.0661; and in the case of a 1920×1080 resolution, a₁₁=9.2697, a₁₂=0.7590, and a₁₃=0.0641. Optionally, when a₉ is equal to 4, and a₁₀ is equal to 1, the freeze event distortion value is greater than or equal to 0 and less than or equal to 4 (0.0≦freezing_artifact_value≦4.0); and when a₉ is equal to 1, and a₁₀ is equal to 1, the freeze event distortion value is greater than or equal to 0 and less than or equal to 1 (0.0≦freezing_artifact_value≦1.0).

In this embodiment of the present invention, the freeze event distortion value of the video stream may also be determined directly according to the frame rate and the freeze feature parameter that are of the video stream.

For example, the freeze event distortion value freezing_artifact_value of the video stream may be determined according to a formula (15):

$$freezing\_artifact \_value = \frac{{a}_{1}}{{a}_{2} + \frac{{a}_{3}}{fps \cdot f\_freezing {\_length}^{{a}_{4}}}} \qquad ( 15 )$$

fps is the frame rate of the video stream; f_freezing_length is the freeze feature parameter of the video stream; MV is the video motion feature parameter of the video stream; and a₁, a₂, a₃, and a₄ are positive constants, where specific values may be obtained by means of training or an empirical value, and may have different values in different resolutions. Optionally, when a₁ is equal to 4, and a₂ is equal to 1, the freeze event distortion value is greater than or equal to 0.0 and less than or equal to 4.0 (0.0≦freezing_artifact_value≦4.0); and when a₁ is equal to 1, and a₂ is equal to 1, the freeze event distortion value is greater than or equal to 0.0 and less than or equal to 1.0 (0.0≦freezing_artifact_value≦1.0).

Therefore, in this embodiment of the present invention, by acquiring a frame rate of a video stream and a freeze feature parameter correlated with duration of a freeze event of the video stream, and acquiring a freeze event distortion value of the video stream according to the frame rate of the video stream and the freeze feature parameter, when an assessment on a freeze event distortion degree is performed, factors considered are more comprehensive and more in line with subjective feelings of people, so that accuracy of distortion degree prediction is improved.

FIG. 2 is a schematic block diagram of an apparatus 200 for assessing a video freeze distortion degree according to an embodiment of the present invention. As shown in FIG. 2, the apparatus 200 includes a first acquiring unit 210 configured to acquire a frame rate and a freeze feature parameter of a freeze event that are of a video stream, where the freeze feature parameter of the freeze event is correlated with duration of the freeze event of the video stream, and the freeze event is used to represent a pause of the video stream; and a second acquiring unit 220 configured to acquire a freeze event distortion value of the video stream according to the frame rate and the freeze feature parameter of the freeze event that are of the video stream, where the freeze event distortion value is used to represent a distortion degree of the video stream.

Optionally, the duration of the freeze event is represented using freeze time or represented using a quantity of freeze frames.

Optionally, when the duration of the freeze event is represented using the quantity of freeze frames, that the freeze feature parameter of the freeze event is correlated with duration of the freeze event of the video stream includes that the freeze feature parameter of the freeze event is represented using a proportional relationship between the quantity of freeze frames and a total quantity of video frames of the video stream; or that the freeze feature parameter of the freeze event is represented using a proportional relationship between the quantity of freeze frames and a quantity of continuous played video frames of the video stream.

Optionally, when the freeze feature parameter of the freeze event is represented using the proportional relationship between the quantity of freeze frames and the total quantity of video frames of the video stream, the first acquiring unit 210 is configured to acquire the frame rate of the video stream; and determine the freeze feature parameter f_freezing_length of the freeze event of the video stream according to a formula

$$f\_freezing \_length = \frac{i\_total \_num \_freezing \_frames}{i\_total \_num \_frames} ,$$

where: i_total_num_frames indicates the total quantity of video frames of the video stream; i_total_num_freezing_frames indicates a quantity of all freeze frames corresponding to the freeze event of the video stream; and f_freezing_length indicates the freeze feature parameter.

Optionally, the second acquiring unit 220 is configured to acquire the freeze event distortion value of the video stream according to a formula

$$freezing\_artifact \_value = \frac{{a}_{1}}{{a}_{2} + \frac{{a}_{3}}{fps \cdot f\_freezing {\_length}^{{a}_{4}}}} ,$$

where: fps is the frame rate of the video stream; f_freezing_length is the freeze feature parameter of the video stream; freezing_artifact_value is the freeze event distortion value; and a₁, a₂, a₃, and a₄ are positive constants.

Optionally, besides acquiring the frame rate and the freeze feature parameter that are of the video stream, the first acquiring unit 210 is further configured to acquire a video motion feature parameter that is of the video stream and is correlated with at least one of a motion change degree and motion consistency that are of the video stream; and the second acquiring unit 220 is configured to acquire the freeze event distortion value of the video stream according to the video motion feature parameter, the frame rate, and the freeze feature parameter of the freeze event that are of the video stream.

Optionally, the first acquiring unit 210 is configured to determine the video motion feature parameter of the video stream according to a motion vector of a coded frame that is before the freeze event of the video stream occurs; or determine the video motion feature parameter of the video stream according to a motion vector of a coded frame that is after the freeze event of the video stream ends; or determine the video motion feature parameter of the video stream according to a motion vector of a coded frame that is before the freeze event of the video stream occurs and a motion vector of a coded frame that is after the freeze event of the video stream ends; or determine the video motion feature parameter of the video stream according to motion vectors of all coded frames of the video stream.

Optionally, the first acquiring unit 210 is configured to determine the video motion feature parameter of the video stream according to a motion vector of the last decoded or displayed inter-frame coded frame that is before the freeze event of the video stream occurs.

Optionally, the second acquiring unit 220 is configured to determine the freeze event distortion value of the video stream according to a formula

$$freezing\_artifact \_value = \frac{{a}_{9}}{{a}_{10} + \frac{{a}_{11}}{fps \cdot f\_freezing {\_length}^{{a}_{12}} \cdot {MV}^{{a}_{13}}}} ,$$

where: fps is the frame rate of the video stream; f_freezing_length is the freeze feature parameter of the freeze event of the video stream; MV is the video motion feature parameter of the video stream; and a₉, a₁₀, a₁₁, a₁₂, and a₁₃ are positive constants.

Optionally, a direction of a correlation between the video motion feature parameter and the motion change degree of the video stream is consistent with a direction of a correlation between the video motion feature parameter and the freeze event distortion value, and a direction of a correlation between the video motion feature parameter and the motion consistency of the video stream is consistent with the direction of the correlation between the video motion feature parameter and the freeze event distortion value.

Optionally, the frame rate is in a positive correlation with the freeze event distortion value, and a direction of a correlation between the freeze feature parameter and the duration of the freeze event is consistent with a direction of a correlation between the freeze feature parameter and the freeze event distortion value.

The foregoing apparatus 200 for assessing video distortion quality may be a terminal, for example, a portable, pocket-sized, handheld, computer-built-in, or vehicle-mounted mobile apparatus; or the apparatus 200 may also be a server, or the like.

It should be understood that, the foregoing or other operations and/or functions of parts in the apparatus 200 for assessing video distortion quality according to this embodiment of the present invention are respectively for implementing corresponding processes of the method 100 in FIG. 1 and FIG. 2. For brevity, details are not described herein again.

Therefore, in this embodiment of the present invention, by acquiring a frame rate of a video stream and a freeze feature parameter correlated with duration of a freeze event of the video stream, and acquiring a freeze event distortion value of the video stream according to the frame rate of the video stream and the freeze feature parameter, when an assessment on a freeze event distortion degree is performed, factors considered are more comprehensive and more in line with subjective feelings of people, so that accuracy of distortion degree prediction is improved.

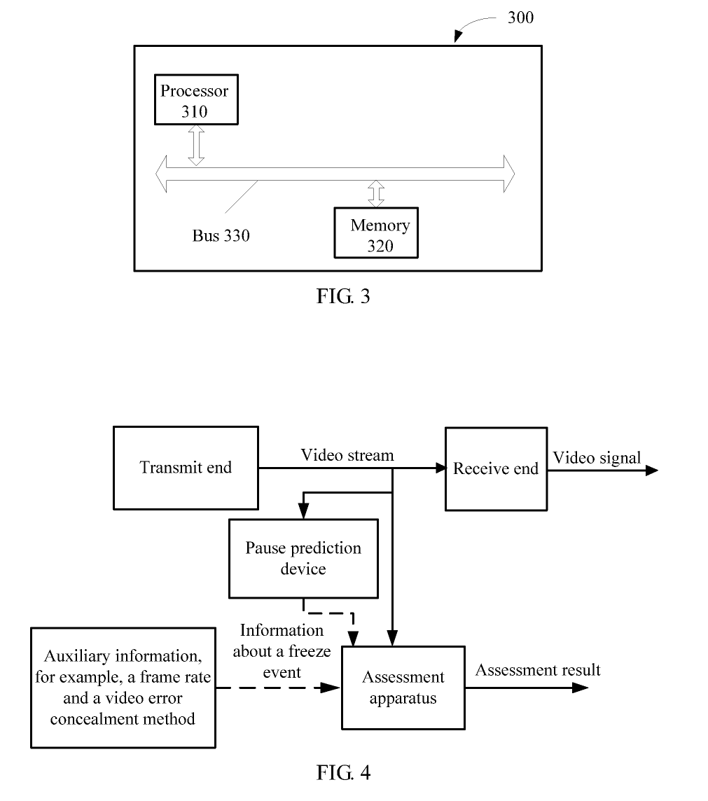

FIG. 3 is a schematic block diagram of an apparatus 300 for assessing video distortion quality according to an embodiment of the present invention. The apparatus 300 includes a processor 310, a memory 320, and a bus 330, where the processor 310 and the memory 320 are connected using the bus 330.

The memory 320 stores a group of program code, and the processor 310 invokes the program code stored in the memory 320 and is configured to perform the following operations: acquiring a frame rate and a freeze feature parameter of a freeze event that are of a video stream, where the freeze feature parameter of the freeze event is correlated with duration of the freeze event of the video stream, and the freeze event is used to represent a pause of the video stream; and acquiring a freeze event distortion value of the video stream according to the frame rate and the freeze feature parameter of the freeze event that are of the video stream, where the freeze event distortion value is used to represent a distortion degree of the video stream.

Optionally, the duration of the freeze event is represented using freeze time or represented using a quantity of freeze frames.

Optionally, when the duration of the freeze event is represented using the quantity of freeze frames, that the freeze feature parameter of the freeze event is correlated with duration of the freeze event of the video stream includes that the freeze feature parameter of the freeze event is represented using a proportional relationship between the quantity of freeze frames and a total quantity of video frames of the video stream; or that the freeze feature parameter of the freeze event is represented using a proportional relationship between the quantity of freeze frames and a quantity of continuous played video frames of the video stream.

Optionally, when the freeze feature parameter of the freeze event is represented using the proportional relationship between the quantity of freeze frames and the total quantity of video frames of the video stream, the processor 310 invokes the program code stored in the memory 320 and is configured to perform the following operations: acquiring the frame rate of the video stream; and determining the freeze feature parameter f_freezing_length of the video stream according to a formula

$$f\_freezing \_length = \frac{i\_total \_num \_freezing \_frames}{i\_total \_num \_frames} ,$$

where: i_total_num_frames indicates the total quantity of video frames of the video stream; i_total_num_freezing_frames indicates a quantity of all freeze frames corresponding to the freeze event of the video stream; and f_freezing_length indicates the freeze feature parameter.

Optionally, the processor 310 invokes the program code stored in the memory 320 and is configured to perform the following operation: acquiring the freeze event distortion value of the video stream according to formula

$$freezing\_artifact \_value = \frac{{a}_{1}}{{a}_{2} + \frac{{a}_{3}}{fps \cdot f\_freezing {\_length}^{{a}_{4}}}} ,$$

where: fps is the frame rate of the video stream; f_freezing_length is the freeze feature parameter of the freeze event of the video stream; freezing_artifact_value is the freeze event distortion value; and a₁, a₂, a₃, and a₄ are positive constants.

Optionally, the processor 310 invokes the program code stored in the memory 320 and is further configured to perform the following operation: besides acquiring the frame rate and the freeze feature parameter that are of the video stream, further acquiring a video motion feature parameter that is of the video stream and is correlated with at least one of a motion change degree and motion consistency that are of the video stream; and is configured to acquire the freeze event distortion value of the video stream according to the video motion feature parameter, the frame rate, and the freeze feature parameter of the freeze event that are of the video stream.

Optionally, the processor 310 invokes the program code stored in the memory 320 and is configured to perform the following operation: determining the video motion feature parameter of the video stream according to a motion vector of a coded frame that is before the freeze event of the video stream occurs; or determining the video motion feature parameter of the video stream according to a motion vector of a coded frame that is after the freeze event of the video stream ends; or determining the video motion feature parameter of the video stream according to a motion vector of a coded frame that is before the freeze event of the video stream occurs and a motion vector of a coded frame that is after the freeze event of the video stream ends; or determining the video motion feature parameter of the video stream according to motion vectors of all coded frames of the video stream.

Optionally, the processor 310 invokes the program code stored in the memory 320 and is configured to perform the following operation: determining the video motion feature parameter of the video stream according to a motion vector of the last decoded or displayed inter-frame coded frame that is before the freeze event of the video stream occurs.

Optionally, the processor 310 invokes the program code stored in the memory 320 and is configured to perform the following operation: determining the freeze event distortion value of the video stream according to a formula

$$freezing\_artifact \_value = \frac{{a}_{9}}{{a}_{10} + \frac{{a}_{11}}{fps \cdot f\_freezing {\_length}^{{a}_{12}} \cdot {MV}^{{a}_{13}}}} ,$$

where: fps is the frame rate of the video stream; f_freezing_length is the freeze feature parameter of the freeze event of the video stream; MV is the video motion feature parameter of the video stream; and a₉, a₁₀, a₁₁, a₁₂, and a₁₃ are positive constants. Optionally, a direction of a correlation between the video motion feature parameter and the motion change degree of the video stream is consistent with a direction of a correlation between the video motion feature parameter and the freeze event distortion value, and a direction of a correlation between the video motion feature parameter and the motion consistency of the video stream is consistent with the direction of the correlation between the video motion feature parameter and the freeze event distortion value.

Optionally, the frame rate is in a positive correlation with the freeze event distortion value, and a direction of a correlation between the freeze feature parameter and the duration of the freeze event is consistent with a direction of a correlation between the freeze feature parameter and the freeze event distortion value.

The foregoing apparatus 300 for assessing video distortion quality may be a terminal, for example, a portable, pocket-sized, handheld, computer-built-in, or vehicle-mounted mobile apparatus; or the apparatus 300 may also be a server, or the like.

It should be understood that, the foregoing or other operations and/or functions of parts in the apparatus 300 for assessing video distortion quality according to this embodiment of the present invention are respectively for implementing corresponding processes of the method 100 in FIG. 1 and FIG. 2. For brevity, details are not described herein again.

Therefore, in this embodiment of the present invention, by acquiring a frame rate of a video stream and a freeze feature parameter correlated with duration of a freeze event of the video stream, and acquiring a freeze event distortion value of the video stream according to the frame rate of the video stream and the freeze feature parameter, when an assessment on a freeze event distortion degree is performed, factors considered are more comprehensive and more in line with subjective feelings of people, so that accuracy of distortion degree prediction is improved.

Apparatuses 200 and 300 in the embodiments of the present invention may be a device independent of a receive end of the video stream, or may be a device integrated inside the receive end.

FIG. 4 is a diagram of a scenario in which an apparatus for assessing a video freeze distortion degree is applied according to an embodiment of the present invention.

As shown in FIG. 4, the apparatus for assessing a video freeze distortion degree is located between a transmit end and a receive end that are of a video stream. A video stream sent by the transmit end is transmitted to the receive end through one channel and transmitted to the assessment apparatus and a pause prediction device through another channel. The assessment apparatus may acquire, from the pause prediction device, information (for example, duration of a freeze event (which may be represented using time) or a starting position of the freeze event) about a freeze event that is of the video stream and is caused by a network delay, and may acquire, from the outside, a frame rate of the video stream and other auxiliary information, for example, a video error concealment method used by a video decoder at the receive end, so that a freeze event caused by a network packet loss may be acquired, and information (for example, duration of the freeze event (which may be represented using a quantity of freeze frames)) about the freeze event is obtained. After acquiring a freeze event distortion value, the apparatus for assessing a video freeze distortion degree may output the freeze event distortion value as an assessment result, or may output a comprehensive assessment result obtained by combining a compression distortion value and/or compression quality and/or other distortion quality.

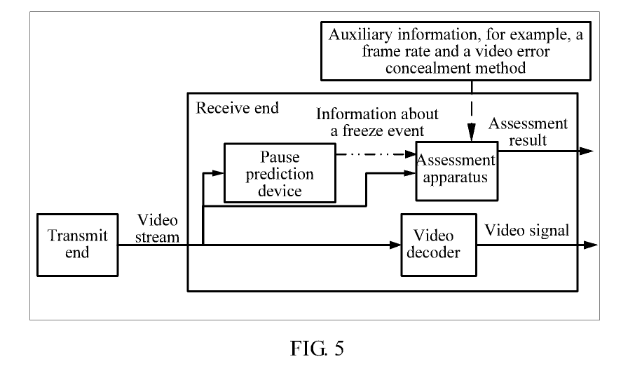

FIG. 5 is a diagram of a scenario in which an apparatus for assessing a video freeze distortion degree is applied according to another embodiment of the present invention.

As shown in FIG. 5, the apparatus for assessing a video freeze distortion degree is integrated inside a receive end of a video stream. After arriving at the receive end, a video stream sent by a transmit end is transmitted to a video decoder through one channel and transmitted to the assessment apparatus and a pause prediction device through another channel. The assessment apparatus may acquire, from the pause prediction device, information (for example, duration of a freeze event (which may be represented using time) or a starting position of the freeze event) about a freeze event that is of the video stream and is caused by a network delay, and may acquire, from the outside, a frame rate of the video stream and other auxiliary information, for example, an error correction policy used by the video decoder at the receive end, so that a freeze event caused by a network packet loss may be acquired, and information (for example, a quantity of freeze frames) about the freeze event is obtained. After acquiring a freeze event distortion value, the apparatus for assessing a video freeze distortion degree may output the freeze event distortion value as an assessment result, or may output a comprehensive assessment result obtained by combining a compression distortion value and/or compression quality and/or other distortion quality.

A video error concealment method described in this embodiment of the present invention may also be understood as a packet loss concealment method (packet loss concealment method). In this technology, a lost packet is not retrieved, and an adverse effect (for example, artifacts or block artifacts) on a decoded video caused by a packet loss is only concealed. For example, an image block or a video frame that is lost or affected by error propagation is recovered using an adjacent error-free image block, or information (for example, pixels or a motion vector) about a previously decoded or displayed error-free image block, or a previously and correctly decoded or displayed error-free video frame.

The apparatus for assessing a video freeze distortion degree in this embodiment of the present invention may also be applied in another scenario. For example, the apparatus for assessing a video freeze distortion degree is integrated into a receive end including a video stream caching device, and acquires information about a freeze event that is of a video stream and is caused by a network delay from the video stream caching device.

Therefore, in this embodiment of the present invention, by acquiring a frame rate of a video stream and a freeze feature parameter correlated with duration of a freeze event of the video stream, and acquiring a freeze event distortion value of the video stream according to the frame rate of the video stream and the freeze feature parameter, when an assessment on a freeze event distortion degree is performed, factors considered are more comprehensive and more in line with subjective feelings of people, so that accuracy of distortion degree prediction is improved.

A person of ordinary skill in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of the present invention.

Methods or steps described in the embodiments disclosed in this specification may be implemented by hardware, a software program executed by a processor, or a combination thereof. The software program may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The present invention is described in detail with reference to the accompany drawings and in combination with the exemplary embodiments, but the present invention is not limited thereto. Various equivalent modifications or replacements can be made to the embodiments of the present invention by a person of ordinary skill in the art without departing from the spirit and essence of the present invention, and the modifications or replacements shall fall within the scope of the present invention.

What is claimed is:

1. A method for assessing a video freeze distortion degree comprising:
acquiring a frame rate and a freeze feature parameter of a freeze event that are of a video stream, wherein the freeze feature parameter of the freeze event is correlated with duration of the freeze event of the video stream, and wherein the freeze event is used to represent a pause of the video stream; and
acquiring a freeze event distortion value of the video stream according to the frame rate and the freeze feature parameter of the freeze event that are of the video stream, wherein the freeze event distortion value is used to represent a distortion degree of the video stream.

2. The method according to claim 1, wherein the duration of the freeze event is represented using freeze time or represented using a quantity of freeze frames.

3. The method according to claim 2, wherein when the duration of the freeze event is represented using the quantity of freeze frames, the freeze feature parameter of the freeze event is correlated with duration of the freeze event of the video stream when:
the freeze feature parameter of the freeze event is represented using a proportional relationship between the quantity of freeze frames and a total quantity of video frames of the video stream; or
the freeze feature parameter of the freeze event is represented using a proportional relationship between the quantity of freeze frames and a quantity of continuous played video frames of the video stream.

4. The method according to claim 3, wherein, when the freeze feature parameter of the freeze event is represented using the proportional relationship between the quantity of freeze frames and the total quantity of video frames of the video stream, acquiring the frame rate and the freeze feature parameter of the freeze event that are of the video stream comprises:
acquiring the frame rate of the video stream; and
determining the freeze feature parameter f_freezing_length of the freeze event of the video stream according to a formula
$$f\_freezing \_length = \frac{i\_total \_num \_freezing \_frames}{i\_total \_num \_frames} ,$$
wherein i_total_num_frames indicates the total quantity of video frames of the video stream, wherein i_total_num_freezing_frames indicates a quantity of all freeze frames corresponding to the freeze event of the video stream, and wherein f_freezing_length indicates the freeze feature parameter of the freeze event.

5. The method according to claim 1, wherein acquiring the freeze event distortion value of the video stream according to the frame rate and the freeze feature parameter of the freeze event that are of the video stream comprises acquiring the freeze event distortion value of the video stream according to a formula
$$freezing\_artifact \_value = \frac{{a}_{1}}{{a}_{2} + \frac{{a}_{3}}{fps \cdot f\_freezing {\_length}^{{a}_{4}}}} ,$$
wherein fps is the frame rate of the video stream, wherein f_freezing_length is the freeze feature parameter of the freeze event of the video stream, wherein freezing_artifact_value is the freeze event distortion value; and wherein a₁, a₂, a₃, and a₄ are positive constants.

6. The method according to claim 1, wherein the method further comprises acquiring a video motion feature parameter that is of the video stream and is correlated with at least one of a motion change degree and motion consistency that are of the video stream, and wherein acquiring the freeze event distortion value of the video stream according to the frame rate and the freeze feature parameter of the freeze event that are of the video stream comprises acquiring the freeze event distortion value of the video stream according to the video motion feature parameter, the frame rate, and the freeze feature parameter of the freeze event that are of the video stream.

7. The method according to claim 6, wherein acquiring the video motion feature parameter of the video stream comprises:
determining the video motion feature parameter of the video stream according to a motion vector of a coded frame that is before the freeze event of the video stream occurs; or
determining the video motion feature parameter of the video stream according to the motion vector of a coded frame that is after the freeze event of the video stream ends; or
determining the video motion feature parameter of the video stream according to the motion vector of a coded frame that is before the freeze event of the video stream occurs and the motion vector of a coded frame that is after the freeze event of the video stream ends; or
determining the video motion feature parameter of the video stream according to the motion vectors of all coded frames of the video stream.

8. The method according to claim 7, wherein determining the video motion feature parameter of the video stream according to the motion vector of the coded frame that is before the freeze event of the video stream occurs comprises determining the video motion feature parameter of the video stream according to a motion vector of the last decoded or displayed coded frame that is before the freeze event of the video stream occurs.

9. The method according to claim 6, wherein acquiring the freeze event distortion value of the video stream according to the video motion feature parameter, the frame rate, and the freeze feature parameter of the freeze event that are of the video stream comprises determining the freeze event distortion value of the video stream according to a formula
$$freezing\_artifact \_value = \frac{{a}_{9}}{{a}_{10} + \frac{{a}_{11}}{fps \cdot f\_freezing {\_length}^{{a}_{12}} \cdot {MV}^{{a}_{13}}}} ,$$
wherein fps is the frame rate of the video stream, wherein f_freezing_length is the freeze feature parameter of the freeze event of the video stream, wherein MV is the video motion feature parameter of the video stream, and wherein a₉, a₁₀, a₁₁, a₁₂, and a₁₃ are positive constants.

10. The method according to claim 6, wherein a direction of a correlation between the video motion feature parameter and the motion change degree of the video stream is consistent with a direction of a correlation between the video motion feature parameter and the freeze event distortion value, and a direction of a correlation between the video motion feature parameter and the motion consistency of the video stream is consistent with the direction of the correlation between the video motion feature parameter and the freeze event distortion value.

11. The method according to claim 1, wherein the frame rate is in a positive correlation with the freeze event distortion value, and wherein a direction of a correlation between the freeze feature parameter of the freeze event and the duration of the freeze event is consistent with a direction of a correlation between the freeze feature parameter of the freeze event and the freeze event distortion value.

12. An apparatus for assessing a video freeze distortion degree comprising:
a first acquiring unit configured to acquire a frame rate and a freeze feature parameter of a freeze event that are of a video stream, wherein the freeze feature parameter of the freeze event is correlated with duration of the freeze event of the video stream, and wherein the freeze event is used to represent a pause of the video stream; and
a second acquiring unit configured to acquire a freeze event distortion value of the video stream according to the frame rate and the freeze feature parameter of the freeze event that are of the video stream, wherein the freeze event distortion value is used to represent a distortion degree of the video stream.

13. The apparatus according to claim 12, wherein the duration of the freeze event is represented using freeze time or represented using a quantity of freeze frames.

14. The apparatus according to claim 13, wherein when the duration of the freeze event is represented using the quantity of freeze frames, and wherein the freeze feature parameter of the freeze event is correlated with duration of the freeze event of the video stream when:
the freeze feature parameter of the freeze event is represented using a proportional relationship between the quantity of freeze frames and a total quantity of video frames of the video stream; or the freeze feature parameter of the freeze event is represented using a proportional relationship between the quantity of freeze frames and a quantity of continuous played video frames of the video stream.

15. The apparatus according to claim 14, wherein, when the freeze feature parameter of the freeze event is represented using the proportional relationship between the quantity of freeze frames and the total quantity of video frames of the video stream, the first acquiring unit is configured to acquire the frame rate of the video stream; and determine the freeze feature parameter f_freezing_length of the freeze event of the video stream according to a formula
$$f\_freezing \_length = \frac{i\_total \_num \_freezing \_frames}{i\_total \_num \_frames} ,$$
wherein i_total_num_frames indicates the total quantity of video frames of the video stream, wherein i_total_num_freezing_frames indicates a quantity of all freeze frames corresponding to the freeze event of the video stream, and wherein f_freezing_length indicates the freeze feature parameter of the freeze event.

16. The apparatus according to claim 15, wherein the second acquiring unit is configured to determine the freeze event distortion value of the video stream according to a formula
$$freezing\_artifact \_value = \frac{{a}_{9}}{{a}_{10} + \frac{{a}_{11}}{fps \cdot f\_freezing {\_length}^{{a}_{12}} \cdot {MV}^{{a}_{13}}}} ,$$
wherein fps is the frame rate of the video stream, wherein f_freezing_length is the freeze feature parameter of the freeze event of the video stream, wherein MV is the video motion feature parameter of the video stream, and wherein a₉, a₁₀, a₁₁, a₁₂, and a₁₃ are positive constants.

17. The apparatus according to claim 12, wherein the second acquiring unit is configured to acquire the freeze event distortion value of the video stream according to a formula
$$freezing\_artifact \_value = \frac{{a}_{1}}{{a}_{2} + \frac{{a}_{3}}{fps \cdot f\_freezing {\_length}^{{a}_{4}}}} ,$$
wherein fps is the frame rate of the video stream, wherein f_freezing_length is the freeze feature parameter of the freeze event of the video stream, wherein freezing_artifact_value is the freeze event distortion value, and wherein a₁, a₂, a₃, and a₄ are positive constants.

18. The apparatus according to claim 12, wherein the first acquiring unit is further configured to acquire a video motion feature parameter that is of the video stream and is correlated with at least one of a motion change degree and motion consistency that are of the video stream, and wherein the second acquiring unit is further configured to acquire the freeze event distortion value of the video stream according to the video motion feature parameter, the frame rate, and the freeze feature parameter of the freeze event that are of the video stream.

19. The apparatus according to claim 18, wherein the first acquiring unit is configured to:
determine the video motion feature parameter of the video stream according to a motion vector of a coded frame that is before the freeze event of the video stream occurs; or
determine the video motion feature parameter of the video stream according to the motion vector of a coded frame that is after the freeze event of the video stream ends; or
determine the video motion feature parameter of the video stream according to the motion vector of a coded frame that is before the freeze event of the video stream occurs and the motion vector of a coded frame that is after the freeze event of the video stream ends; or
determine the video motion feature parameter of the video stream according to the motion vectors of all coded frames of the video stream.

20. The apparatus according to claim 19, wherein the first acquiring unit is configured to determine the video motion feature parameter of the video stream according to a motion vector of the last decoded or displayed coded frame that is before the freeze event of the video stream occurs.

21. The apparatus according to claim 18, wherein a direction of a correlation between the video motion feature parameter and the motion change degree of the video stream is consistent with a direction of a correlation between the video motion feature parameter and the freeze event distortion value, and wherein a direction of a correlation between the video motion feature parameter and the motion consistency of the video stream is consistent with the direction of the correlation between the video motion feature parameter and the freeze event distortion value.

22. The apparatus according to claim 12, wherein the frame rate is in a positive correlation with the freeze event distortion value, and wherein a direction of a correlation between the freeze feature parameter of the freeze event and the duration of the freeze event is consistent with a direction of a correlation between the freeze feature parameter of the freeze event and the freeze event distortion value.
